(19) United States
(12) Patent Application Publication
(10) Pub. No.: US 2026/0340260 A1
(43) Pub. Date: Oct. 29, 2026

(54) CHARACTER CODE AND DISPLAY DEVICE

(71) Applicant: Nichido Solutions Inc., Sakaiminato-shi (JP)

(72) Inventors: Ali Cemal DOGAL, Tottori (JP); Kenta Selim ISHIDA, Tottori (JP); Kohei Halil ISHIDA, Tottori (JP)

(73) Assignee: Nichido Solutions Inc., Sakaiminato-shi (JP)

(21) Appl. No.: 19/415,762

(22) Filed: Dec. 10, 2025

Related U.S. Application Data
(63) Continuation of application No. PCT/JP2025/004522, filed on Feb. 12, 2025.

(51) Int. Cl. G06F 40/126; G06T 11/10

(52) U.S. Cl. CPC G06F 40/126; G06T 11/10

(57) ABSTRACT

Provided is a character code including 27 types of character symbols, each of which is formed by arranging, in a line, three arbitrary character elements selected from among three different types of character elements, 26 letters of an alphabet and one space symbol being respectively assigned to the character symbols. Also provided is a display device including a display capable of displaying character symbols in accordance with this character code, a processor, and a memory. The character code and the display device enables reading by a computer and a user, and allows a larger number of digits of information to be contained in a narrow space.

### CROSS-REFERENCE TO RELATED APPLICATIONS

This is a continuation of International Application PCT/JP2025/004522, with an international filing date of Feb. 12, 2025, which is hereby incorporated by reference herein in its entirety.

### TECHNICAL FIELD

The present disclosure relates to a character code and a display device.

### BACKGROUND

One-dimensional barcodes or two-dimensional barcodes have conventionally been known as computer-readable codes (for example, see PTL 1 and PTL 2).

For example, a JAN code (GTIN-13, GTIN-8) as a standard one-dimensional barcode expresses seven zones (modules) by combining two black bars and two white bars for representing a number. In addition, in what is called a customer barcode described in PTL 1, a character is assigned to a code composed of 2-bit, 4-state (upper and lower, upper, lower, and none) three bars arranged with gaps therebetween.

### CITATION LIST

### Patent Literature

### PTL 1

Japanese Unexamined Patent Application, Publication No. H9 -212569

### PTL 2

The Publication of Japanese U.S. Pat. No. 6,034,404

### SUMMARY

An aspect of the present disclosure is directed to a character code comprising 27 types of character symbols, each of which is formed by arranging, in a line, three arbitrary character elements selected from among three different types of the character elements, 26 letters of an alphabet and one space symbol being respectively assigned to the character symbols.

Another aspect of the present disclosure is directed to a display device comprising: a display capable of displaying the character symbols in accordance with the above-described character code; and at least one processor, wherein the processor acquires a word written in the alphabet, acquires a word represented by the character symbols corresponding to the acquired word written in the alphabet, and displays the acquired word represented by the character symbols on the display.

Still another aspect of the present disclosure is directed to a display device comprising a display capable of displaying the character symbols in accordance with the above-described character code, the display device comprising at least one processor and at least one memory, wherein the memory stores each of the character symbols in association with a corresponding letter of the alphabet, and the processor acquires a word written in the alphabet, converts the acquired word written in the alphabet as acquired into a word represented by corresponding character symbols based on stored contents of the memory, and displays the converted word represented by the character symbols on the display.

### BRIEF DESCRIPTION OF DRAWINGS

FIG. 1 is a diagram showing an example of three character elements constituting a character symbol of a character code according to an embodiment of the present disclosure.

FIG. 2 is a diagram describing a configuration of the character symbol of the character code in FIG. 1.

FIG. 3 is a diagram showing an example of 27 types of character symbols formed by combining the character elements in FIG. 1, a top row enumerating the 27 types of character symbols, a middle row showing the character symbols with alphabetical assignments, and a bottom row showing the character elements with their frames removed.

FIG. 4 is a diagram showing an example of a word in accordance with the character code in FIG. 1.

FIG. 5 is a diagram showing an example of frequently used words in accordance with the character code in FIG. 1.

FIG. 6 is a diagram showing an example of frequently used words similarly to FIG. 5.

FIG. 7 is a diagram showing an example of character symbols assigned with alphabet letters D, F, and H in FIG. 3.

FIG. 8 is a diagram showing a preferable example (marked with “O” on the right side) and an undesirable example (marked with “X” on the left side) of a word obtained by the first optimization.

FIG. 9 is a diagram showing a preferable example (marked with “O” on the right side) and an undesirable example (marked with “X” on the left side) of a word obtained by the second optimization.

FIG. 10 is a diagram showing a preferable example (marked with “O” on the right side) and an undesirable example (marked with “X” on the left side) of a word obtained by the third optimization.

FIG. 11 is a diagram showing a preferable example (marked with “O” on the right side) and an undesirable example (marked with “X” on the left side) of a word obtained by the fourth optimization.

FIG. 12 is a diagram showing modifications of the character symbol in FIG. 2.

FIG. 13 is a diagram showing an example of character symbols to which numbers are assigned.

FIG. 14 is a schematic diagram showing a display device according to an embodiment of the present disclosure.

FIG. 15 is a diagram describing an example of display provided by the display device in FIG. 14.

FIG. 16 is a diagram describing another example of display provided by the display device in FIG. 14.

FIG. 17 is a diagram describing a comparison between a character code having a reduced character width displayed on the display device and alphabet letters, as well as a comparison between the character code in which the space symbol has a further reduced character width and the alphabet letters.

FIG. 18 is a diagram showing an example of a setting display when using the display device in FIG. 14 for brain training.

FIG. 19 is a diagram showing an example of text displayed by the display device in FIG. 14 when the number of registered words is small.

FIG. 20 is a diagram showing an example of text displayed by the display device in FIG. 14 when the number of registered words increases.

FIG. 21 is a diagram showing a modification of a word in accordance with the character code in FIG. 1.

FIG. 22 is a diagram showing another modification of a word in accordance with the character code in FIG. 1.

### DESCRIPTION OF EMBODIMENTS

Hereinafter, a character code and a display device 10 according to an embodiment of the present disclosure will be described with reference to the drawings.

As shown in FIG. 2, the character code according to the present embodiment is composed of a character symbol 2 in which three character elements 1 are arranged in a line. Each of the character elements 1 constituting the character symbol 2 is selected from among three different types of character elements 1a to 1c.

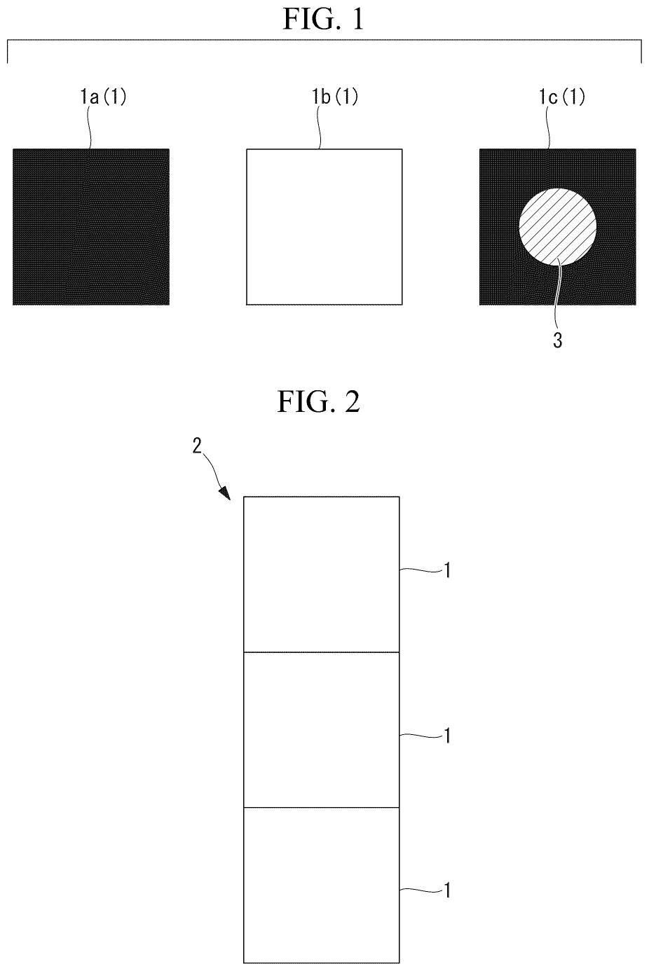

As three types of the character elements 1a to 1c, any elements may be employed as long as they can be recognized as different from each other. In the present embodiment, as shown in FIG. 1, the first character element 1a, the second character element 1b, and the third character element 1c, each formed by a square having an identical size and shape, are employed.

In the present embodiment, description is made by taking, for example, a case where a background color of a region in which the character symbol 2 is displayed is white.

The first character element la is a square filled with a color different from the background color, such as black.

The second character element 1b is a square filled with the same color as the background color, or a transparent square or a frame thereof.

The third character element 1c is a square having a circular dot 3 at the center, an outside of the dot 3 being filled with the same color as that of the first character element 1a, such as black, and an inside of the dot 3 being filled with a color different from that of the outside, such as green. The dot 3 may be a true circle or may be an ellipse or an oval.

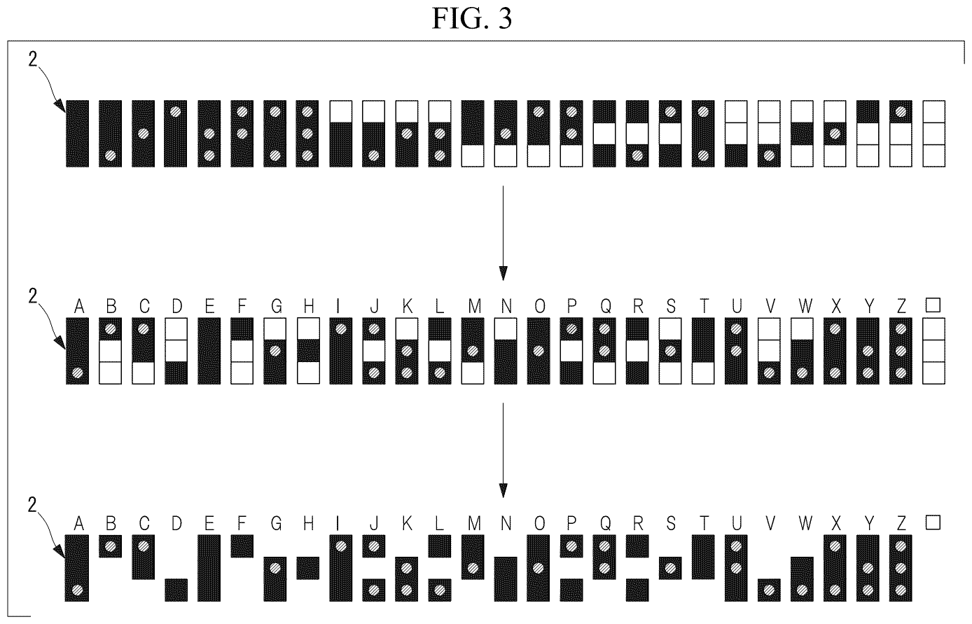

As shown in the top row of FIG. 3, there are 3×3×=27 types of character symbols 2, in which any three character elements 1 selected from among the three different types of the character elements 1a to 1c are arranged in a line. The character code according to the present embodiment is constituted by assigning 26 letters of the alphabet and one space symbol to these 27 types of character symbols 2. A user is able to freely edit the assignment of the 26 letters of the alphabet and the one space symbol to the character symbols.

FIG. 3 shows, in the top row, the 27 types of character symbols 2 constituting the character code according to the present embodiment and shows, in the middle row, an example in which a corresponding letter of the alphabet is assigned to each of these character symbols 2. The bottom row of FIG. 3 shows the 27 types of character symbols 2 in the case where the second character elements 1b in the character symbols 2 in the middle row are squares of the same color as the background color and have no frame.

The character code according to the present embodiment is optimized by a method described below.

First, vowels “A”, “E”, “I”, “O”, and “U” of the alphabet are each assigned to any one of the character symbols 2 that are composed of only the first character element 1a, only the third character element 1c, or only the first character element 1a and the third character element 1c. These character symbols 2 have the three character elements 1 composed of entirely black-colored or black-colored squares having the dots 3 and are thus the character symbols 2 (hereinafter referred to as full-height character symbols) of black-colored rectangle having a height equivalent to the three character elements 1.

Since a word usually involves a vowel, the above optimization enables one or more full-height character symbols to be present in a logogram. For a similar reason, the alphabet letter “Y”, which frequently appears in a word, is assigned to any full-height character symbol. Accordingly, a full-height character symbol can also be contained in a word having no vowel, such as “RYTHM”, for example.

Second, the alphabet letters are assigned to the character symbols 2 so as to ensure at least one linkage in the lateral direction between adjacent two character symbols 2 in many words.

Third, the assignment of the alphabet letters to the character symbols 2 is optimized using frequency analysis of a large-scale corpus so as to minimize the number of the dots 3.

Fourth, the assignment of the alphabet letters to the character symbols 2 is optimized using frequency analysis of the large-scale corpus so as to reduce the number of required black-colored squares to the minimum. For example, less frequently used X and Z are assigned to any one of the full-height character symbols.

The operation of the character code according to the present embodiment thus configured will be described below.

According to the character code of the present embodiment, a letter of the alphabet or a space symbol is assigned to each of the 27 types of character symbols 2 each composed of the three character elements 1 arranged longitudinally in a line. Thus, a plurality of the character symbols 2 constituting a word can be arranged closely with no gaps between one another in a lateral direction intersecting the longitudinal direction, which is a direction in which the character elements 1 are arranged.

In other words, there is an advantage in that, even if the character symbols 2 are brought close to each other, the character code of the present embodiment does not lose its meaning, since it does not contain a gap between the character symbols 2 unlike a barcode. In addition, since the character symbols 2 can be brought close to each other, the character symbols 2 can be arranged more densely in the lateral direction than the alphabet, which requires gaps between letters, or a barcode, thereby improving space efficiency. Therefore, a larger number of digits of characters can be arranged in a smaller space to contain a larger amount of information than that of a one-dimensional barcode or the like.

In addition, the character symbols 2 in the present embodiment are always monospaced. The monospaced font is optimal for coding, tables, and terminals, since it enables correct alignment of the character symbols 2 having a fixed width. Furthermore, the monospaced font can also provide improved accessibility and a unique aesthetic value.

Furthermore, since the character code of the present embodiment is composed of the character symbols each having a simple shape formed only by arranging the three character elements 1 longitudinally in a line, it can be easily read with a code reader similarly to a customer code. In the case where the alphabet is read with a reader, the recognition accuracy based on pattern recognition varies depending on the font, whereas the character code according to the present embodiment, which is composed of the character symbols each having a simple shape, enables accurate reading.

Moreover, since a letter of the alphabet is assigned to a character symbol arranged longitudinally in a line, a user can directly read the character code without using a code reader, unlike a barcode or a customer code. Therefore, the user can read the character code without the alphabet written alongside. In particular, even in a situation where a code reader cannot be activated, such as in a case where a system is down, the user is able to understand display content.

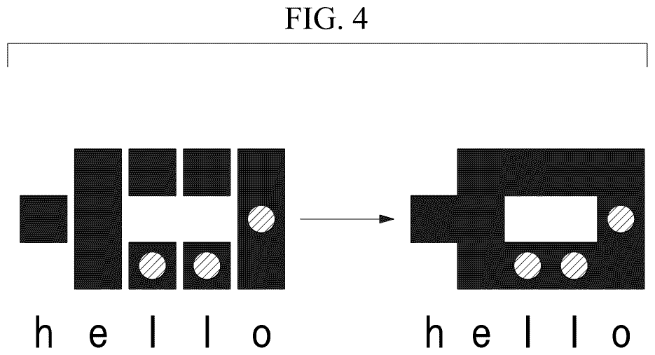

FIG. 4 shows an example in which the word “hello” written in the alphabet, which is common in English, is expressed using the character symbols 2 in the bottom row of FIG. 3.

According to this example, five character symbols 2 constituting the word are brought close in the lateral direction with no gaps therebetween. As a result, a logogram having a shape in which one or more character symbols 2 are coupled in the lateral direction like building blocks is formed for one word.

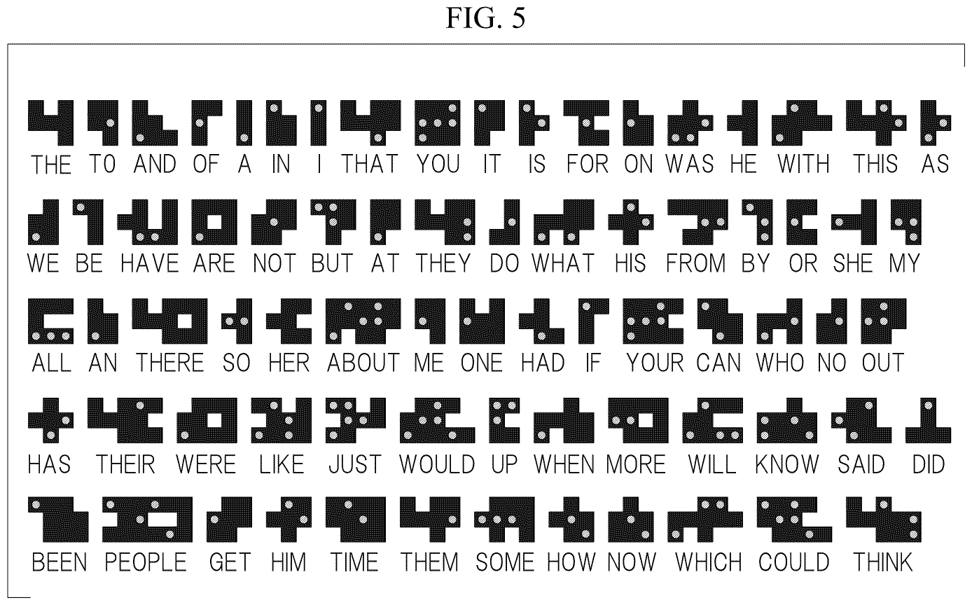

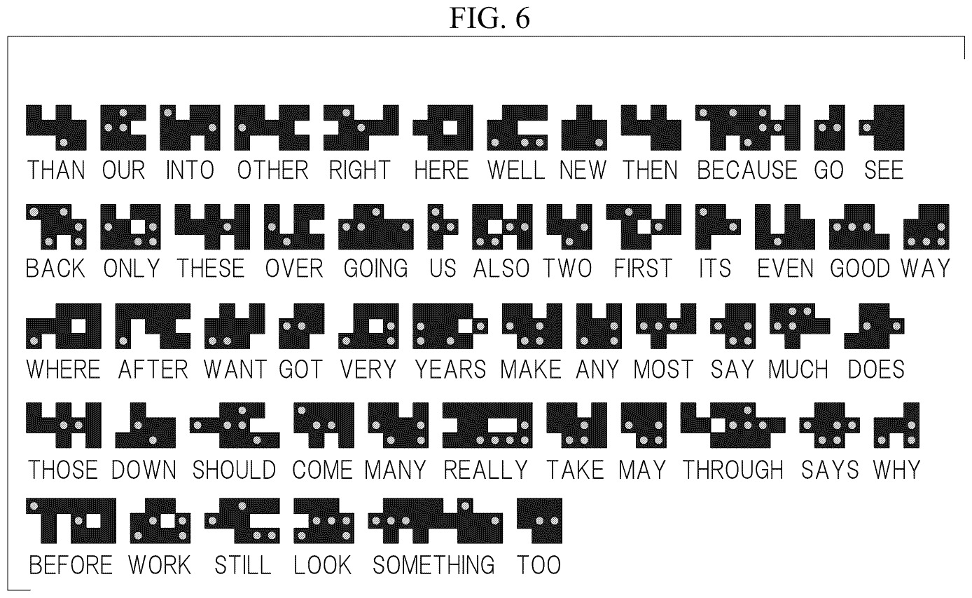

FIGS. 5 and 6 show examples in which common words in English are expressed by the character code according to the present embodiment with the alphabet written alongside. Each word is expressed as a logogram having a different shape. As described above, in addition to a word being legible by reading the character symbols 2 themselves constituting the character code, the character code can be read more easily by memorizing the meaning of the word in association with the shape of the logogram. Once the shapes can be identified through training, words can be understood more intuitively and quickly from the shapes, enabling rapid reading of text.

The character symbol arranged longitudinally in a line also has an effect of reducing the burden on recognition by a computer or a user, since it has no unnecessary strokes unlike alphabet letters, thereby improving efficiency in reading a document. In addition, the required time on recognition of the character symbols by a computer can be shortened, thereby improving recognition accuracy.

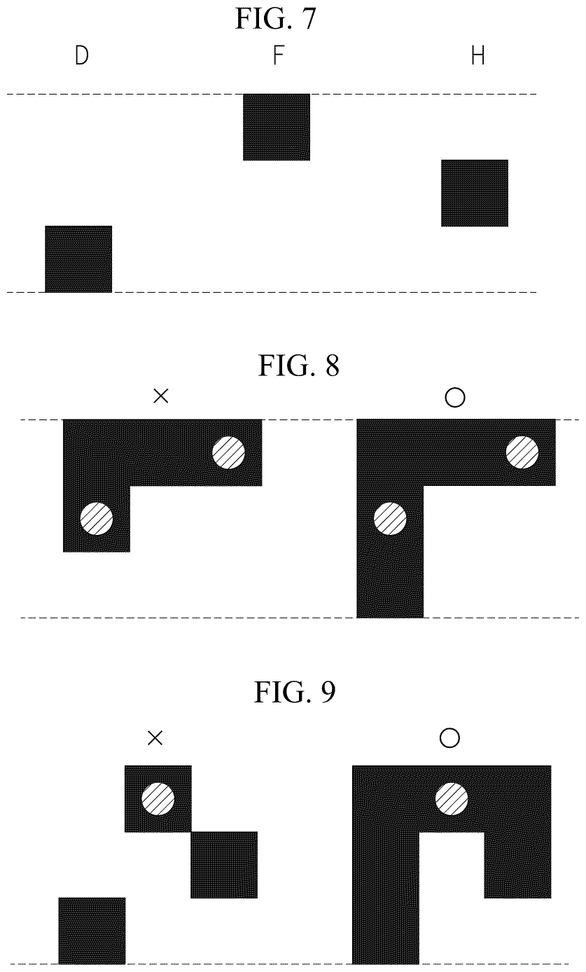

In addition, according to the character code of the present embodiment offers an advantage such that almost all words can be formed into logograms understandable on their own by means of the first optimization. For example, in the case where a word is composed of the character symbols 2 in the bottom row of FIG. 3, a character symbol composed of a single black-colored square or a character symbol 2 in which two black-colored squares continue can be identified only after the lowermost position is indicated. For example, “D”, “F”, and “H” in the bottom row of FIG. 3 cannot be identified unless the lowermost position or the uppermost position is indicated with a guideline or the like as shown in FIG. 7. The same applies to “B”, “S”, and “V”; “C” and “G”; “M” and “W”; and “K” and “Q”, and the like.

Through the first optimization, as shown in FIG. 8, the lowermost and uppermost positions of the character symbols 2 can be clearly indicated due to the presence of a vowel or “Y” in a word, so that the user can easily identify the character symbols 2 and the word. In addition, there is an advantage in that meaning can be identified solely by a logogram depicted on blank paper without guideline, without using additional means such as guideline to identify the lowermost or uppermost position.

In addition, through the second optimization, as shown in FIG. 9, a logogram constituting a word can appear continuously without separation.

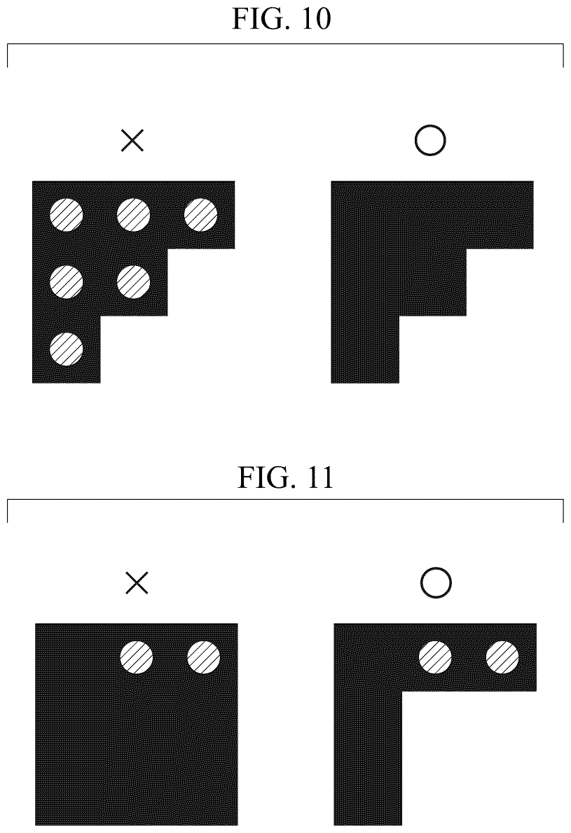

In addition, through the third optimization, as shown in FIG. 10, the number of the third character elements 1c in a word can be reduced, thereby ensuring that the user can read more easily and efficiently.

In addition, through the fourth optimization, as shown in FIG. 11, the first character element 1a can be less used in character symbols in which a letter other than the vowels and “Y” appears frequently. In particular, in order to reduce the total amount of black-colored quadrangles, the number of connections is counted as one even if there are multiple connections between the patterns when counting the number of connections between the character symbols 2, thereby preventing a pattern having many black-colored quadrangles from being given preference. This can eliminate such a logogram having a shape of a mere black-colored quadrangle and can lessen an excessive cognitive burden.

The character code according to the present embodiment can be applied to the following application purposes, for example:
Traffic signs for autonomous vehicles and drivers This enables both human drivers and autonomous vehicles to interpret traffic instructions seamlessly.
Product labels for smart retail and logistics This provides consumers with detailed information of products and assists automated systems in stock management and checkout operations.
Medical equipment and patient identification This ensures accurate identification of patients by both medical staff and hospital robots.
Autonomous delivery and smart logistics This enables both human delivery personnel and drones to accurately manage delivery operations using dually readable package labels.
Public transport systems and smart city infrastructures This enhances public transportation signs and AI-driven traffic systems for commuters for work and school.
Warehouse/manufacturing automation This enables streamlining of inventory and quality management performed by human workers and automated robots.
Traceability for supply chains This enables tracing by quality inspectors and blockchain systems using dually readable labels for food and pharmaceutical products.
Construction/infrastructure projects

This ensures coordinated assembly using blueprints and components that are labeled for both workers and construction drones.
Aviation and airport services

This enables streamlining of processes performed by staff and sorting systems using dually readable boarding tickets and luggage tags.
Marine navigation

This enables improvement in safety and docking efficiency using port signs legible to human and autonomous ships.
Military logistics and equipment management

This enables seamless tracing by soldiers and automated inventory systems using dually readable identifiers for equipment.

In addition, the character code according to the present embodiment can be incorporated as a dually readable module into a barcode. This enables identification of items and display of signals. Furthermore, the character code according to the present embodiment is a general-purpose tool adapted to a broad range of applications and can be utilized for item verification and signal transmission in addition to its original purpose. Therefore, the character code according to the present embodiment is highly reliable even in an emergency situation, such as when a power outage or system failure occurs. In such cases, since a trained personnel can manually read the code, the dependence on scanners can be reduced. Specifically, it has advantages useful in emergency applications (such as rescue operations or military operations independent of electric power and electronic devices) and educational fields (such as contributing to the refinement of Braille and supporting people with dyslexia (reading disorder) ). In other words, the flexibility of this system allows it to meet a wide range of needs beyond its primary purpose.

In addition, the character code according to the present embodiment is arranged in sequence like a one-dimensional barcode. Since a structured pattern rather than a uniform bar is employed for the character code, camera-based scanning can be effectively performed, as in a two-dimensional barcode. In addition, a laser scanner can also be refined so as to support this coding.

In addition, the character code according to the present embodiment is provided in, for example, a format such as text, an image, a vector, machine-readable data, or others. Accordingly, this system can provide higher accuracy and superior performance under various scanning conditions, since it utilizes pattern recognition rather than OCR, unlike the case where a font is employed.

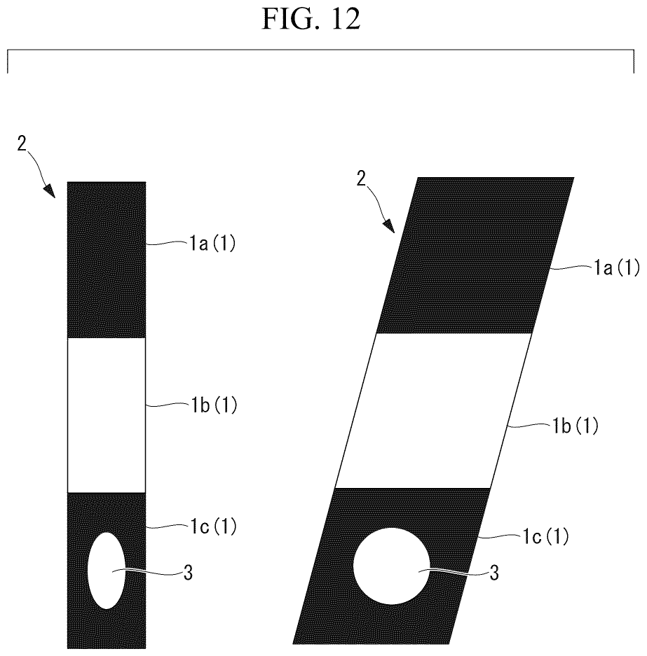

Note that, in the character code according to the present embodiment, the three types of character elements 1a to 1c each composed of a square having an identical size are exemplified. Alternatively, the character elements 1 of any other shape may be employed. For example, as shown in FIG. 12, any parallelogram, such as a rectangle or a rhombus may be employed as the character element 1.

In addition, the first character element la and the third character element 1c are defined as having the same black-filled square, but they may be filled with another single color or multiple colors. In addition, the second character element 1b is defined as being filled with the same color as the background, but may be filled with another color distinguishable from the first character element 1a and the third character element 1c.

In addition, a quadrangle having sharp corners has been exemplified as each of the character elements 1, whereas a quadrangle having rounded or chamfered corners may be employed.

In addition, the character symbol 2 may alternatively be formed by arranging the three character elements 1 laterally in a line, whereas, in the present embodiment, the character symbol 2 is formed by arranging the three character elements 1 longitudinally in a line. In this case, the character symbols 2 may be arranged longitudinally to form a word in a longitudinal direction.

In addition, the third character element 1c having the dot 3 of any shape, such as a polygon, star, or pictorial symbol, may alternatively be employed, whereas the third character element 1c having the circular dot 3 at the center of a parallelogram is exemplified.

In addition, the inside of the dot 3 of the third character element 1c is defined to be filled with a color different from that of the outside, but may alternatively be filled with the same color as the background color or may be transparent to the background color.

In addition, a small gap may alternatively be provided between the adjacent character symbols 2, whereas, in the present embodiment, the character code in which the character symbols 2 are arranged closely is employed. This gap has such a size that the character code is not degraded in meaning or function. By so doing, the visibility of the character code can be improved.

In addition, four or more character elements 1 may alternatively be combined into a line to constitute the character symbol 2, whereas, in the present embodiment, the three character elements 1 are combined into a line to constitute one character symbol 2. By so doing, the character code can also be adapted to a greater number of letters or letters other than those of the alphabet.

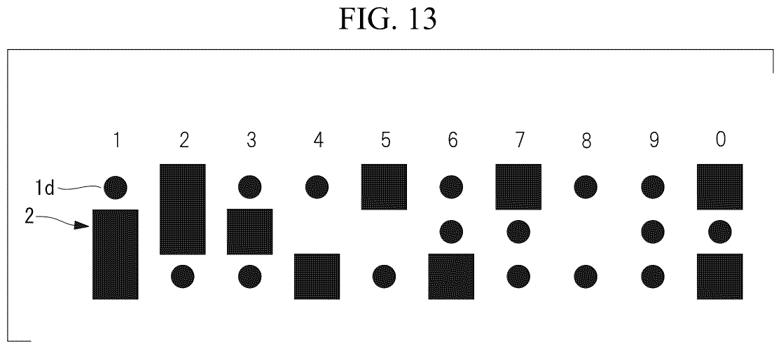

In addition, numbers and symbols may be arranged in text as they are without being contained in the character code of the present embodiment. In addition, a fourth character element 1d which is distinguishable from the first to third character elements 1a to 1c may be used for a number or the like to be added as part of the character code according to the present embodiment. For example, as shown in FIG. 13, the fourth character element 1d obtained by inverting the third character element 1c may be used.

Next, the display device 10 according to the embodiment of the present disclosure will be described below with reference to the drawings.

The display device 10 according to the present embodiment is capable of displaying the character code described above and may be implemented as a portable computer such as a smartphone or tablet, or as a personal computer such as a notebook or desktop computer. It is preferable that the display device 10 communicate with the outside via a wired or wireless connection.

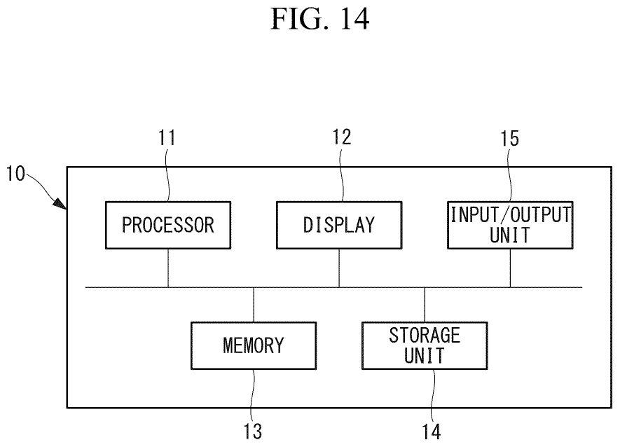

As shown in FIG. 14, the display device 10 includes a processor 11, a display 12, a memory 13, a storage unit 14, and an input/output unit 15 connected with buses.

The processor 11 is constituted by a CPU, a quantum processor, or the like. The display 12 is constituted by a liquid crystal display device, an organic EL display device, or the like. In the present embodiment, the display 12 also functions as a user interface that receives user operation by being controlled by the processor 11.

The memory 13 is constituted by a DRAM or the like and temporarily stores data necessary for the processor 11 to execute processing.

The storage unit 14 is constituted by a hard disk drive or an SSD, a flash memory, or the like. The storage unit 14 stores an operation program for causing the processor 11 to execute operation which will be described later and data necessary for the operation, and the like.

As shown in the bottom row of FIG. 3, the memory 13 stores the character symbols 2 in association with the alphabet letters. In addition, the memory 13 is capable of registering at least one word written in the alphabet.

The processor 11 acquires a word or text written in the alphabet. In addition, the processor 11 converts the acquired word written in the alphabet into a word represented by the corresponding character symbols 2 based on the stored contents of the memory 13. In addition, the processor 11 displays the converted word represented by the character symbols 2, on the display 12.

The input/output unit 15 is an input/output interface that communicates with an external device (not shown) under control of the processor 11 to export data stored in the memory 13 to the outside or import data from the external device.

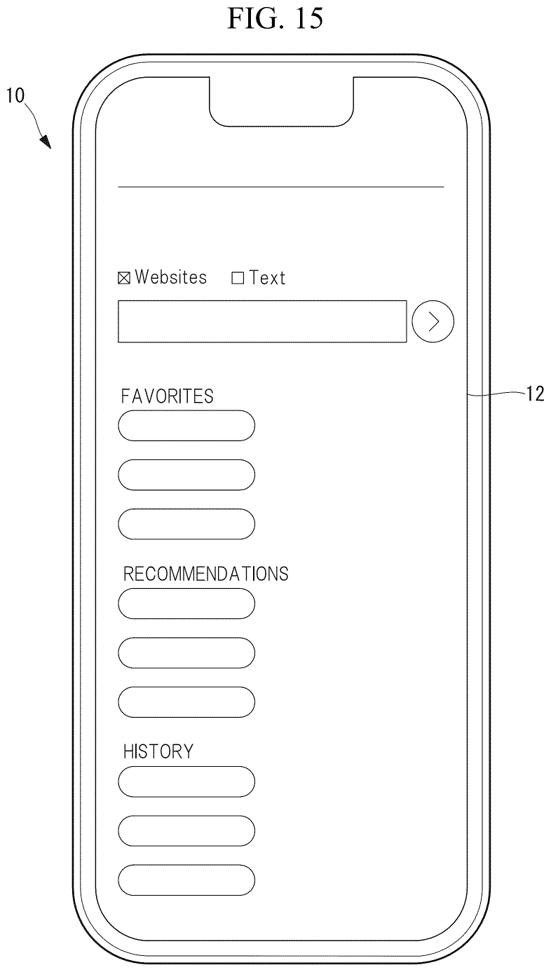

The acquisition of text by the processor 11 is carried out via the display 12 and the input/output unit 15. In particular, as shown in FIG. 15, the processor 11 displays a URL field, favorites, history, and recommendations, and the like on the display 12.

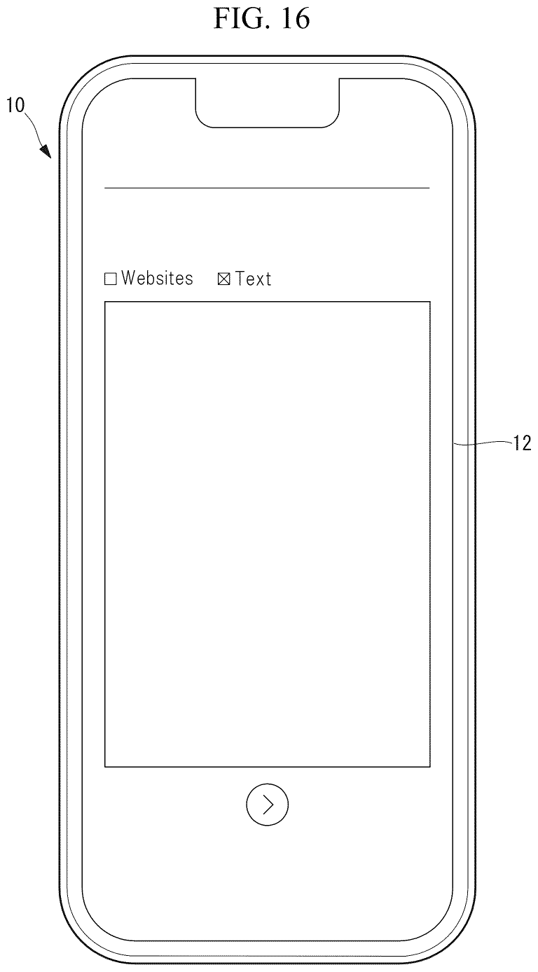

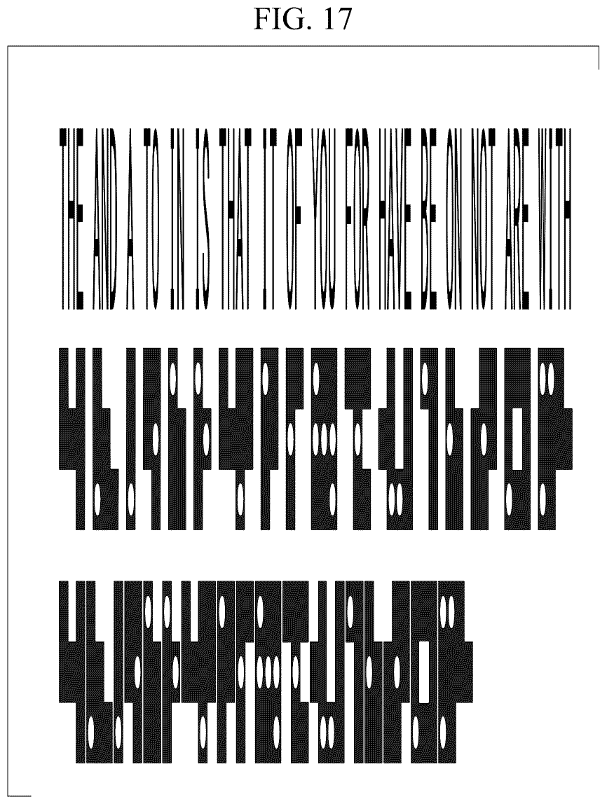

A user inputs a keyword or URL in the URL field, or selects a favorite, a history, a recommendation, or the like to open a web site. Then, text posted on the web site is imported, or, as shown in FIG. 16, text data is imported into the display device 10 via copy and paste.

The processor 11 converts a word written in the alphabet in the text written in the alphabet into a character code using the association between the alphabet letters and the character symbols 2 stored in the memory 13 and displays the converted character code on the display 12.

This enables the user to read text represented by the character code instead of the text written in the alphabet.

In this case, the processor 11 arranges the character symbols 2 constituting each word closely in the lateral direction. As described above, with the character code according to the present embodiment, since each of the character symbols 2 is composed of the simple shape arranged longitudinally in a line, the visibility does not deteriorate even if the character width is reduced, as shown in the middle row of FIG. 17. The character symbols 2 constituting a word can be arranged tightly in the lateral direction. This also reduces space needed for displaying text having the same meaning. The top row of FIG. 17 displays corresponding alphabet letters with character widths and character heights substantially equivalent to those of the character code in the middle row.

However, because gaps are required between letters, space efficiency is poor, and some letters have lost their legibility.

In addition, the character code according to the present embodiment, which minimizes unnecessary strokes, enables the user to read text without feeling excessive recognition burden. For example, the efficiency of reading when the user reads text displayed on the display 12 can be improved.

In addition, the display device 10 according to the present embodiment can function as a training device for learning the character code according to the present embodiment.

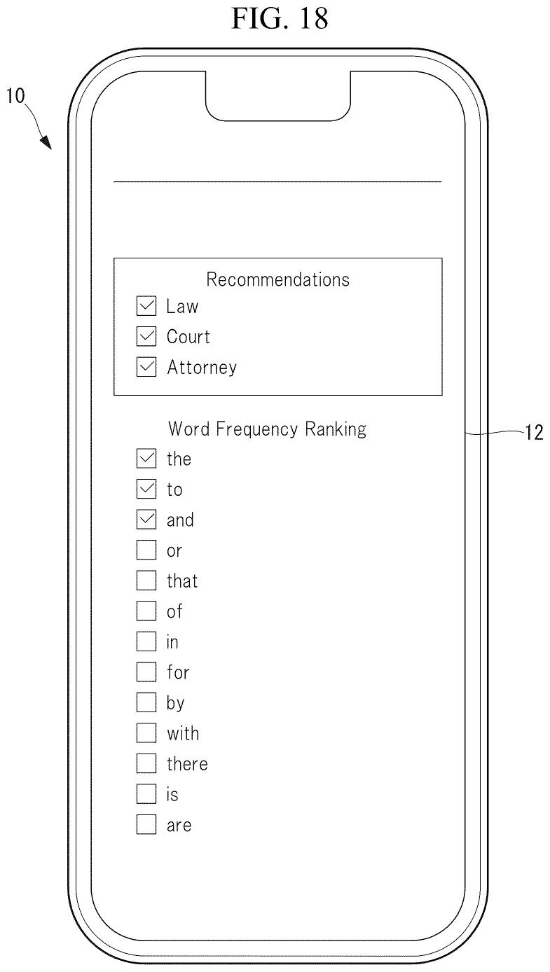

For example, the processor 11 continually analyzes all displayed text, including past history, to extract words written in the alphabet that the user wishes to display using the character code according to the present embodiment. As shown in FIG. 18, the processor 11 then enumerates the extracted words in descending order of use frequency of words present in text and displays them as recommended words and frequently appearing words on the display 12. The user places checkmarks in boxes corresponding to the words displayed on the display 12 to select words. The words with the checkmarks are registered in the memory 13.

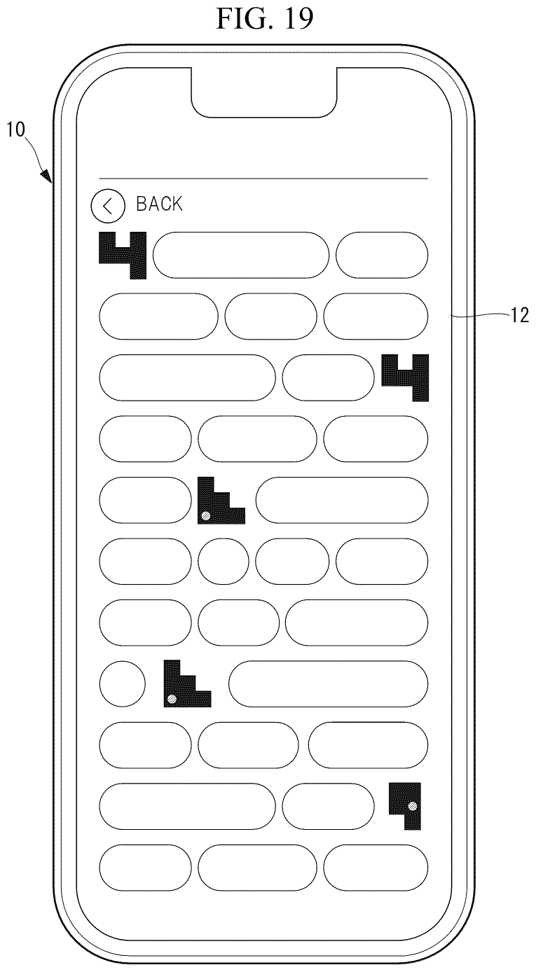

The processor 11 converts, from the captured text, the words written in the alphabet registered in the memory 13 into the character code using the association between the alphabet letters and the character symbols stored in the memory 13. Then, as shown in FIG. 19, only words converted to the character code are displayed using the character symbols 2, while the remainder is displayed using alphabetical notation on the display 12. In the drawing, rounded blanks indicate that the alphabet is displayed.

In this case, the processor 11 does not convert a portion of a word in the captured text into the character code even if that portion matches the alphabet registered in the memory 13. For example, in the case where an alphabetic word registered in the memory 13 is “THE”, only “THE” with no letters at both ends is converted into the character code, and “THE” in “OTHEr” or “eiTHEr” is not converted.

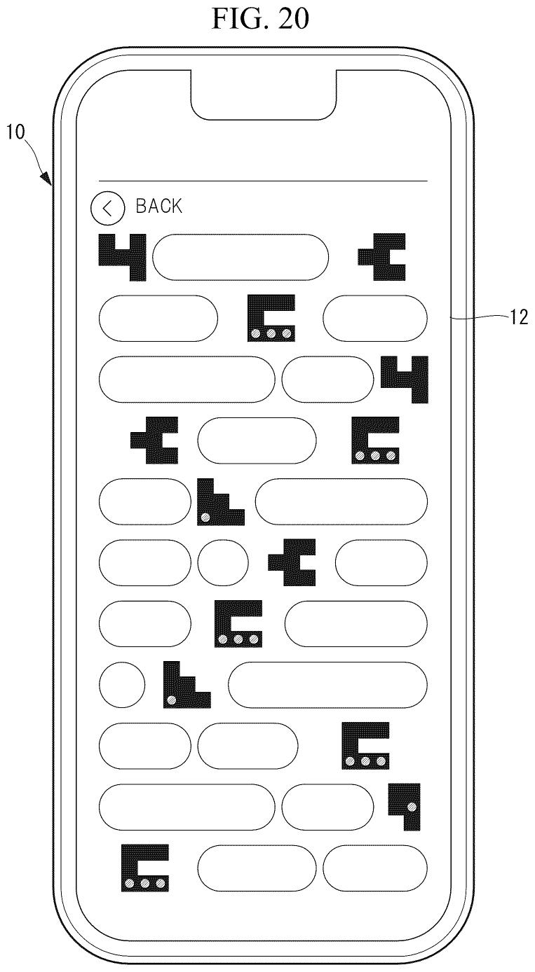

According to the display device 10 configured in this manner, the user initially places checkmarks only on a small number of words for which the semantic content of the logograms can be recognized. The user can thus read mostly alphabetically written text, as shown in FIG. 19. As the number of recognizable words increases and the checkmarks accumulate, the user can read text in which a larger number of words have been replaced by logograms, as shown in FIG. 20. The user can thus use this display device 10 from the beginning of logogram learning, as logograms increase according to proficiency, and can be utilized the display device 10 for brain training.

Furthermore, in this embodiment, the character symbol 2 containing no gaps is exemplified; however, alternatively, a character containing small gaps may be employed. This can improve visibility.

In addition, in the present embodiment, the display 12 displaying the URL field, favorites, history, and recommendations, and the like is exemplified. In addition to this, the display 12 displaying a share button may be employed. This enables the user to open a web site with a mobile reader application using the share button.

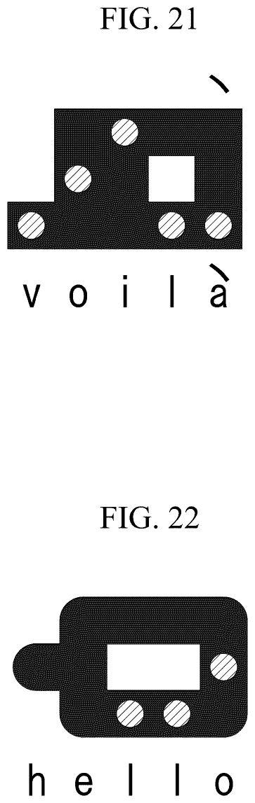

In addition, in the present embodiment, a character code in which a diacritical mark can be used may be employed as shown in FIG. 21. A language other than English can thereby be supported.

In addition, a character code in which uppercase and lowercase letters are distinguished may alternatively be employed, whereas, in the present embodiment, the character code in which uppercase and lowercase letters are not distinguished is exemplified. In particular, uppercase and lowercase letters can be distinguished by adding marks indicating the uppercase letters afterward as needed.

In addition, in the present embodiment, as shown in FIG. 22, a character code designed to give a soft impression by rounding the corners may be employed.

In addition, in the present embodiment, English alphabet letters are exemplified as characters adopted, but this is not limited thereto. Letters from other languages (such as, for example, Japanese hiragana, Japanese katakana, Chinese, German, or Arabic script, etc.) may also be employed as characters.

In addition, in the present embodiment, the memory 13 included in the display device 10 is exemplified; however, alternatively, the memory 13 may be included in a server connected to the display device 10 via a network. In this case, the server may acquire the character symbols 2 input to the display device 10, search for the corresponding alphabet letters in the memory 13, and output them. In the display device 10, the processor 11 may acquire a word written in the alphabet output from the server via the network, acquire a word represented by character symbols corresponding to the acquired word written in the alphabet, and display the acquired word represented by the character symbols on the display 12.

In addition, in the present embodiment, the character code composed of the character symbols 2, each formed by arranging the three character elements 1 in a line, is exemplified; however, this is not limited thereto. In particular, a character code may be employed which is composed of up to N³ types of character symbols 2, each of which is formed by arranging, in a line, N arbitrary character elements 1 selected from N different types of character elements 1 (N being a natural number), and by assigning a letter to each of the character symbols 2.

Although an embodiment and modifications of the present disclosure have been described above, the character code and the display device of the present disclosure are not limited to the embodiment and modifications described above and may be variously changed without departing from the scope of the present disclosure.

### REFERENCE SIGNS LIST

1 character element
1a first character element
1b second character element
1c third character element
2 character symbol
3 dot
10 display device
11 processor
12 display
13 memory

1. A character code comprising 27 types of character symbols, each of which is formed by arranging, in a line, three arbitrary character elements selected from among three different types of character elements, 26 letters of an alphabet and one space symbol being respectively assigned to the character symbols.

2. The character code according to claim 1, wherein the three arbitrary character elements are parallelograms having an identical size and shape and comprise a first character element filled with a color different from a background color, a second character element filled with a color different from the color of the first character element, and a third character element having a dot inside.

3. The character code according to claim 2, wherein an outside of the dot of the third character element is filled with a same color as the color of the first character element.

4. The character code according to claim 3, wherein vowels “A”, “E”, “I”, “O”, and “U” of the alphabet are each assigned to any one of the character symbols that are composed of only the first character element, only the third character element, or only the first character element and the third character element.

5. The character code according to claim 4, wherein “Y” of the alphabet is assigned to any one of the character symbols that are composed of only the first character element, only the third character element, or only the first character element and the third character element.

6. A display device comprising:
a display capable of displaying the character symbols in accordance with the character code according to claim 1; and
at least one processor,
wherein the processor is configured to acquire a word written in the alphabet, acquire a word represented by the character symbols corresponding to the acquired word written in the alphabet, and display the acquired word represented by the character symbols on the display.

7. A display device comprising a display capable of displaying the character symbols in accordance with the character code according to claim 2, the display device comprising:
at least one processor; and
at least one memory,
wherein
the memory stores each of the character symbols in association with a corresponding letter of the alphabet, and
the processor is configured to acquire a word written in the alphabet, convert the acquired word written in the alphabet into a word represented by corresponding character symbols based on stored contents of the memory, and display the converted word represented by the character symbols on the display.

8. The display device according to claim 7, wherein the processor is configured to display, on the display, a plurality of the character symbols that constitute the word represented by the character symbols, the plurality of the character symbols being arranged closely in a direction intersecting an arrangement direction of the character elements.

9. The display device according to claim 7, wherein
the space symbol is assigned to a character symbol composed of only the second character element, and
the processor is configured to display the character symbol on the display such that a dimension in a direction intersecting an arrangement direction of the character elements of the character symbol to which the space symbol is assigned is smaller than that of other character symbols.

10. The display device according to claim 7, wherein
the memory is capable of registering at least one of the words written in the alphabet, and
the processor is configured to acquire text written in the alphabet, convert the at least one of the words written in the alphabet selected from among words registered in the memory in the acquired text into the character symbols, and display the converted text on the display.

11. The display device according to claim 10, wherein the processor is configured to enumerate the words present within the acquired text in descending order of frequency of use and displays them on the display to prompt a user to make a selection.

12. A character code comprising up to N³ types of character symbols, each of which is formed by arranging, in a line, N arbitrary character elements selected from N different types of character elements (N being a natural number), a letter being assigned to each of the character symbols.
